(19) United States
(12) Patent Application Publication
(10) Pub. No.: US 2020/0334868 A1
(43) Pub. Date: Oct. 22, 2020

(54) METHOD, DEVICE AND DATA-PROCESSING APPARATUS FOR COMPUTER-AIDED HAIR DYE COLORING GUIDANCE

(71) Applicant: HENKEL AG & CO. KGAA, Duesseldorf (DE)

(72) Inventors: Felipe ZILLY CLAUDE, Leverkusen (DE); Georg KNÜBEL, Düsseldorf (DE); Thomas FÖRSTER, Düsseldorf (DE); Peyman AZHARI, Dortmund (DE)

(73) Assignee: Henkel AG & Co. KGaA, Duesseldorf (DE)

(21) Appl. No.: 16/320,795

(22) PCT Filed: Jul. 14, 2017
(86) PCT No.: PCT/EP2017/067916

§ 371 Date: Jan. 25, 2019

(30) Foreign Application Priority Data
Jul. 27, 2016 (DE) 10 2016 213 754.9

(51) Int. Cl. G06T 11/00; G06T 7/90; A45D 44/00

(52) U.S. Cl. CPC G06T 11/001; G06T 7/90; A45D 44/005; A45D 2044/007; G06T 2207/30196; G06T 2207/10012; G06T 2207/10024

(57) ABSTRACT

In various exemplary embodiments, a method for computer-aided hair color counseling is provided. The method may comprise: recording a digital image of hair of a user and additional objects by employing a camera, identifying a hair region area in the digital image in which the hair is depicted, identifying a new hair color, aligning a hair projection region in which the hair is projected, of a transparent or reflecting screen or a system of screen and one-way mirror in a manner such that, to an observer of the screen, a combination of the objects transmitted or reflected by the screen is produced with the hair projection region, wherein the hair projection region is aligned in a manner such that it essentially covers a hair transmission/reflection region in which to the observer, the transmitted or reflected user's hair would appear, and projecting the hair projection region in the new hair color.

### CROSS-REFERENCE TO RELATED APPLICATION

This application is a U.S. National-Stage entry under 35 U.S.C. § 371 based on International Application No. PCT/EP2017/067916, filed Jul. 14, 2017 which was published under PCT Article 21(2) and which claims priority to German Application No. 10 2016 213 754.9, filed Jul. 27, 2016, which are all hereby incorporated in their entirety by reference.

### TECHNICAL FIELD

The present disclosure relates to computer-aided hair dye counseling.

### BACKGROUND

A user who wishes to dye their hair (also known as coloring) would usually like to obtain a hair color which suits their taste and hair type.

Obtaining a desired result when coloring their hair is of vital importance to the user, and a decision regarding a hair dye could be facilitated if an expected color result could be quickly and reliably presented to the user in a congenial manner. A “reliable representation” should be understood here to mean that the presented expected color result essentially corresponds to the actual color result.

Computer-aided hair dye counseling may, for example, be used in this regard to communicate to a user a visual impression as to how a selected desired hair color could look on them. As an example, in a digital image of the user, on which, inter alia, their hair can be seen, a region of the image is identified in which hair is presented. This hair region can be recolored in the desired hair color.

For conventional computer-aided hair dye counseling, typically, a personal device, for example a mobile phone or a tablet, is required. The digital device may, for example, be used to execute a hair color counseling app.

Installing such an app can be time-consuming and complicated. Furthermore, even with a tablet, a screen can be comparatively small, so that a sufficiently large presentation is not available (for example for an evaluation of the color result).

Furthermore, the user cannot concentrate on a result on the app because they are busy operating and holding the device.

In addition, the reliability of the presentation of the color result may be questionable, because typically, the whole image is displayed on the screen, recolored in the hair region, so that a deviation from reality involving the entire image, for example uniform coloring of the entire image, might not be apparent.

Furthermore, the hair of the user, both before and also after coloring, typically does not have either a single shade or a single brightness, but a multiplicity of shades and/or brightness levels.

In other words, a light situation may be extraordinarily heterogeneous at different places on the hair of the user. As an example, the hair on the side facing a light source can appear lighter and on the side away from the light source (in the shadow), it can appear darker.

A light or shade/brightness situation of the hair by a colorimetric measurement with precisely controlled illumination can only provide an averaged approximate description. Thus, a realistic presentation of the color result to be expected on monitors, panels and/or in print is made more difficult.

Thus, there is a need for hair color counseling in which a hair color result can be presented easily, rapidly, congenially and reliably.

### BRIEF DESCRIPTION OF THE DRAWINGS

The present disclosure will hereinafter be described in conjunction with the following drawing Figs., wherein like numerals denote like elements, and:

FIG. 1 shows a diagrammatic presentation of a device for carrying out computer-aided hair color counseling in accordance with various exemplary embodiments;

FIGS. 2A, 2B and 2C show graphical representations to illustrate a method for computer-aided hair color counseling in accordance with various exemplary embodiments;

FIG. 3 shows a graphical presentation to illustrate a method for computer-aided hair color counseling in accordance with various exemplary embodiments;

FIG. 4 shows a graphical presentation to illustrate a method for computer-aided hair color counseling in accordance with various exemplary embodiments;

FIG. 5 shows a flow chart which represents a method for computer-aided hair color counseling in accordance with various exemplary embodiments;

FIG. 6 Shows a flow chart which represents a method for presenting a hair color result in accordance with various exemplary embodiments; and

FIG. 7 Is a graphical presentation of a data processing device for carrying out a method for presenting a hair color result in accordance with various exemplary embodiments.

### BRIEF SUMMARY

Devices and methods for computer-aided hair color counselling and methods for presenting hair color results are provided. In an exemplary embodiment, a method includes recording a digital image of hair of a user and additional objects by employing a camera, and identifying a hair region area in the digital image in which the hair is depicted. A new hair color is identified, and a hair projection region is aligned in which the hair is projected by a screen such that, to an observer of the screen, a combination o the objects projected by the screen is produced with the hair projection region where the hair projection region is aligned such that is essentially covers a hair transmission/reflection region in which the projected user's hair would appear to an observer. The new hair color is projected in the hair projection region.

A device for computer-aided hair color counselling is provided in another embodiment. The device includes at least one camera to record a digital image of hair of a user and additional object. The device also includes a processor configured to identify a hair region area in the digital image, and an input device for the user to select a new hair color. The device further includes a screen to project a hair projection region in the new hair color, where the hair projection region is aligned such that a combination of the objects transmitted or reflected by the screen is produced with the hair projection region, where the hair projection region about coves a hair transmission/reflection region where the transmitted or reflected hair of the user would appear to an observer.

A method of presenting a hair color result is provided in another embodiment. The method includes, for each coloring process of a plurality of coloring processes: measuring a colorimetric measurement of uncolored hair for a plurality of measuring points; determining a plurality of “before” mean color values from the colorimetric measured values for the plurality of measuring points for the uncolored hair; measuring a colorimetric measurement of colored hair for a plurality of measuring points; determining an “after” mean color value for the colorimetric measured values for the plurality of measuring points for the colored hair; determining a plurality of color difference values from the plurality of “before” mean color values and the “after” mean color value; incorporating correction factors for a very dark or very light point; and determining a relationship between the “before” mean color values and the plurality of color difference values using predictive analytics; The method also includes providing a digital image that comprises at least one hair region area of a user, and determining color values for a plurality of image elements of the user hair region area. A user “before” mean color value is determined from the color values for the plurality of image elements from the user hair region area, and a new hair color is selected by the user. An expected color result is determined using the user “before” mean color value and the determined relationship, and the expected color result is presented by displaying at least a portion of the digital image in which the hair region area is recolored with the aid of the expected color result.

### DETAILED DESCRIPTION

The following detailed description is merely exemplary in nature and is not intended to limit the disclosure or the application and uses of the subject matter as described herein. Furthermore, there is no intention to be bound by any theory presented in the preceding background or the following detailed description.

In various exemplary embodiments, a camera can be coupled with a reflecting or transparent OLED screen by employing a software-controlled computer connection. The at least one camera can record a user, i.e. make one or more images of the user. By employing the software, a position of the hair of the user (as a part of the image which is also described as the hair region area) can be identified. After identifying or determining which hair color (also known as a hair color) is to be tested, at a position on the screen at which the hair region area is located (reflected or shows through, also described as the hair transmission/reflection region), an OLED projection (i.e. OLED display) of an expected hair color result is produced.

In the case of the reflecting screen, the user can see the expected result by employing the reflecting and projecting screen. In other words, upon observing the screen, the user can see a combination of the reflected objects, for example their face, body, background items etc, and the projected recolored hair color region, which together illustrate how the user would look with the new hair color.

In the case of the transparent screen, one or more other persons can observe the result to be expected by employing the transparent and projecting screen. In other words, the other persons, upon observing the screen (for example from the side which is behind the screen from the user's observation point), sees a combination of transmitted objects, for example the user's face and/or body, background items etc, and the projected recolored hair color region which together illustrate how the user would look with the new hair color.

In various exemplary embodiments, with a light-transmitting screen, a mirror which is behind the screen as seen by the user may be provided so that the user can observe the result even when a light-transmitting screen is used, as a reflection of the combination of the transmitted objects with the projection of the recolored hair color region using the mirror.

In various exemplary embodiments, instead of the OLED screen, a (for example conventional) screen may be used in combination with a one-way mirror (see in this regard the Wikipedia article “one-way mirror” in the version dated 25 Jul. 2016 (URL: https://en.wikipedia.org/wiki/One-way_mirror).

In this regard, the hair region area as described above can be identified with the camera and projected by employing the (for example conventional) screen to the one-way mirror so that to the observer, an overlay of the light transmitted by the one-way mirror with the projection of the (for example recolored) hair region area is produced.

In various exemplary embodiments, the presentation (also described as the projection or display) of the expected hair color result may be optimized or is optimized by employing a color and/or brightness reference. In this regard, the device for computer-aided hair color counseling may comprise a sensor for a color and/or brightness reference. The color and/or brightness reference can be read using software in order to calibrate the presentation of the expected hair color result. The color and/or brightness reference may, for example, comprise a reference map or be a reference map. In various exemplary embodiments, the sensor may be the camera which records the user. Alternatively, an additional camera may be used.

In various exemplary embodiments, for example when a new hair color is provided by employing a printed image, a determination of the hair coloration may also be optimized by employing the color and/or brightness reference.

In various exemplary embodiments, additional information may be displayed to the user on the screen.

In various exemplary embodiments, a user may be independent of apps for a presentation of a possible hair color result, i.e. the user does not need a personal device.

In various exemplary embodiments, an enlarged presentation of the possible hair color result (than, for example, would be available on a smartphone or tablet) may be possible.

In various exemplary embodiments, the method and the device for computer-aided hair color counseling can be carried out easily (or more simply).

In various exemplary embodiments, the method and the device for computer-aided hair color counseling enables a more true-to-life and much faster presentation of the possible hair color result to be obtained, because only the hair region area is modified (and presented) by the computer, and no other computer-controlled interventions are carried out on the image perceived by the user.

In various exemplary embodiments, the possible hair color result can be observed live. The user can therefore concentrate on observing the result and thus does not have to control their own device.

In various exemplary embodiments, the expected hair color result may readily be visible by another person when using a transparent screen. The recorded person (the user) does not in fact obscure the presentation of the hair color result, because the other persons can observe the screen from a side of the screen which is away from the user.

In various exemplary embodiments, color values may be determined for the presentation of the hair color region in a new hair color, by employing a method which uses predictive analytics in order to determine a relationship between the starting parameters and a color difference (which may be a difference, for example a difference vector, between a mean of colors in the hair region prior to coloring and a mean of colors in the color region after coloring) with the aid of a plurality of starting parameters (for example components of a dye formula, the original hair color of the user, the degree of damage to the user's hair, etc) and a training set with hair color results for a portion of the plurality of starting parameters.

In accordance with various exemplary embodiments, the determined color difference may be used in order, by using a depiction of a hairstyle, for example on a digital image, to color each image element of a hair region by employing the color difference. In this regard, the color difference value may be added to the color value of each image element of the hair region.

In various exemplary embodiments, correction factors may be used for very light or very dark regions; as an example, in the L, a, b color space, L, a and b do not take any value but, for example, are limited to the ranges of L: 0-100, a: −170 to +100 and b: −100 to +150.

In various exemplary embodiments, the presented hair color result may be pleasant because naturally present illumination and shadowed regions can be retained. Furthermore, the color result may be realistic, for example when using a parameterization of the colors to be represented in a color space (for example L*a*b*) which is independent of the device. The Lab color space here may also represent color spaces which may be more suitable for additive colors, for example CIELUV or /1/2/3/.

In various exemplary embodiments, a method for computer-aided hair color counseling is provided. The method may comprise: recording a digital image of hair of a user and additional objects by employing a camera, identifying a hair region area in the digital image in which the hair is depicted, identifying a new hair color, aligning a hair projection region in which the hair is projected, of a transparent or reflecting screen in a manner such that, to an observer of the screen, a combination of the objects transmitted or reflected by the screen is produced with the hair projection region, wherein the hair projection region is aligned in a manner such that it essentially covers a hair transmission/reflection region in which to the observer, the transmitted or reflected user's hair would appear, and projecting the hair projection region in the new hair color.

In various exemplary embodiments, recording the digital image, identifying the hair region area and presenting the hair region area colored with the new hair color can be repeated in a manner such that a quasi-real time presentation is produced.

In various exemplary embodiments, the identification of the new hair color may comprise selecting the new hair color from a plurality of selectable new hair colors provided by employing a database.

In various exemplary embodiments, the provision of a plurality of selectable new hair colors may comprise displaying a selection menu on the screen.

In various exemplary embodiments, identifying the new hair color may comprise measuring a hair coloring product by employing a sensor.

In various exemplary embodiments, the user may also be the observer.

In various exemplary embodiments, the method may furthermore comprise correcting the new hair color by employing the color and/or brightness reference.

In various exemplary embodiments, alignment of the hair projection region may comprise arranging the user, the screen, the observer and the camera in a manner such that the hair projection region covers the hair transmission/reflection region when the hair projection region of the hair region area corresponds to a mirror image configuration of the whole digital image which fills the screen.

In various exemplary embodiments, alignment of the hair projection region may comprise adjusting a zoom factor of the camera.

In various exemplary embodiments, alignment of the hair projection region may comprise recording a positional reference.

In various exemplary embodiments, alignment of the hair projection region may comprise recording spatial information regarding the user and the additional objects.

In various exemplary embodiments, the method may further comprise projecting the hair projection region in an original hair color of the user.

In various exemplary embodiments, the method may further comprise correcting the projection of the hair projection region by a color correction value, a brightness correction value, or a color/brightness correction value with the aid of an overall impression of the combination of the objects transmitted or reflected by the screen with the hair projection region.

In various exemplary embodiments, projecting the new hair color may comprise a method for presenting a hair color result in accordance with one of the exemplary embodiments described herein.

In various exemplary embodiments, the method may furthermore comprise presenting at least one colorant which is associated with the selectable new hair color.

In various exemplary embodiments, a device for carrying out computer-aided hair color counseling is provided. The device may comprise: at least one camera to record a digital image of hair of a user and additional objects, a processor, wherein the processor is configured to identify the hair region area in the digital image of the user, an input device for the user to select a new hair color, and a light-transmitting or reflecting screen or a system of screen and one-way mirror to project a hair projection region in the new hair color, wherein the hair projection region is aligned in a manner such that, for an observer of the screen, a combination of the objects transmitted or reflected by the screen is produced with the hair projection region, in which the hair projection region essentially covers the hair transmission/reflection region in which, to the observer, the transmitted or reflected hair of the user would appear.

In various exemplary embodiments, the screen is an OLED screen.

In various exemplary embodiments, the at least one camera may be disposed in a manner such that its at least one optical axis is perpendicular to a surface of the screen facing the user.

In various exemplary embodiments, the screen may be the light-emitting screen. The device may furthermore comprise a mirror which is disposed behind the screen from the user's point of view, such that the user can see in the mirror the combination of the objects transmitted or reflected by the screen with the hair projection region.

In various exemplary embodiments, the input device may comprise a touch-sensitive surface of the screen.

In various exemplary embodiments, the device may further comprise a sensor to capture spatial information regarding the user.

In various exemplary embodiments, a method for presenting a hair color result is provided. The method may comprise: for each coloring process of a plurality of coloring processes: colorimetric measurement of uncolored hair for a plurality of measuring points, determining a “before” mean color value from the colorimetric measured values for the plurality of measuring points for the uncolored hair, colorimetric measurement of colored hair for a plurality of measuring points, determining an “after” mean color value from the colorimetric measured values for the plurality of measuring points for the colored hair, and determining a color difference value from the “before” mean color value and the “after” mean color value, incorporating correction factors for very dark or very light points, determining a relationship between the plurality of “before” mean color values and the plurality of color difference values using predictive analytics, providing a digital image which comprises at least one hair region area of a user, determining color values for a plurality of image elements of the user hair region area, determining a user “before” mean color value from the determined color values for the plurality of image elements from the user hair region area, selection of a new hair color by the user, determining an expected color result using the user “before” mean color value and the determined relationship, and presenting the expected color result by displaying at least a portion of the digital image in which the hair region area is recolored with the aid of the expected color result.

In various exemplary embodiments, the determination of an expected color result may comprise: identifying an associated color difference value with the aid of the determined relationship, and wherein the new color of the hair region area may comprise recoloring the plurality of image elements of the user hair region area by adding the color difference value to the determined color value for each image element of the plurality of image elements of the user hair region area.

In various exemplary embodiments, in order to display the digital image, a device in accordance with various exemplary embodiments described herein may be used.

In various exemplary embodiments, a data processing device is provided for carrying out computer-aided hair color counseling, wherein the data processing device may be configured to carry out the method for computer-aided hair color counseling in accordance with various exemplary embodiments.

In various exemplary embodiments, a data processing device for carrying out a method for displaying a hair color result is provided, wherein the data processing device may be configured to carry out the method for computer-aided hair color counseling in accordance with various exemplary embodiments.

r

In the following comprehensive description, reference will be made to the accompanying drawings which form part of the present application and in which specific embodiments in which the present disclosure may be carried out are shown by way of illustration. In this regard, the orientational terminology such as, for example, “top”, “bottom”, “lower”, “in front of”, “at the back of”, “front”, “rear”, etc are made with reference to the orientation of the described Fig.(s). Because components of embodiments can be positioned in a number of different orientations, the orientation terminology is for illustration purposes and is in no way limiting in scope. It should be understood that other embodiments may be used and structural changes or changes to logic may be made without departing from the scope of the present disclosure. It should be understood that the features of the various exemplary embodiments may be combined together, as long as no specific statement is made to the contrary. The following detailed description should therefore not be construed as being limiting in its nature, and the scope of protection of the present disclosure is defined in the attached claims.

The term “digital image” as used herein can be understood to mean a data package which can be presented by a data processing system as a two-dimensional (laminar) arrangement of picture elements, for example in a coordinate system which has an x axis and a y axis, wherein each picture element has associated with it at least one piece of color information which, for example, can be presented as a color of a pixel of a monitor or a printed dot of a printed image. In this manner, the digital image may be a photo recorded with a digital camera or a single image from a video sequence recorded with a digital camera (wherein in accordance with various embodiments, the method may be applied to a plurality of individual images of the video sequence).

The terms “hair region” and “hair region area” are used synonymously herein. The hair region may comprise a plurality of picture elements of a digital image which represent hair and which may be formed from a coherent area or from a plurality of individual areas. A plane in which the hair region may be disposed may, for example, be defined by the x axis and the y axis of the digital image.

The term “color” as used herein should be understood to mean a cooperation of a shade (i.e. a spectral impression of color, also known as a hue), which may be understood to refer to the “actual color”), a color intensity (i.e. how intensive the color appears, for example compared with a neutral grey—also described as saturation, color saturation, colorfulness, chromaticity or depth of color) and a brightness (i.e. how light or dark the color appears).

In various exemplary embodiments, the color information may, for example, comprise a parameterization in a known color space, for example in a L*a*b* color space (wherein L*, the lightness, refers to the brightness of a color, a* to the green and red component and b* to the blue and yellow component of the color), in a RGB color space by color components in red, green and blue, in a CMYK color space by color fractions in cyan, magenta, yellow and black, or in any other color space, for example CIELUV or /1/2/3/.

The term “shade” as used herein, as described above, should be understood to mean the spectral color impression of a color, independently of how it is parameterized, for example as a point in a two-dimensional color space (for example a*b* in the L*a*b* system) or a ratio of color components (such as, for example, in the RGB color space or in the CMYK color space).

In various exemplary embodiments, a color space from which the color information (hair color information and image color information) derives may be generated in a manner such that a determined or displayed color is independent of a medium through which the color is determined or displayed (for example screen, printer, scanner, human eye, etc). The color space may, for example, be a L*a*b* color space, and the color information may, for example, be a shade parameterized using a* and b*. The consistent presentation in the medium-independent color space means that an expected color result which is close to reality can be presented.

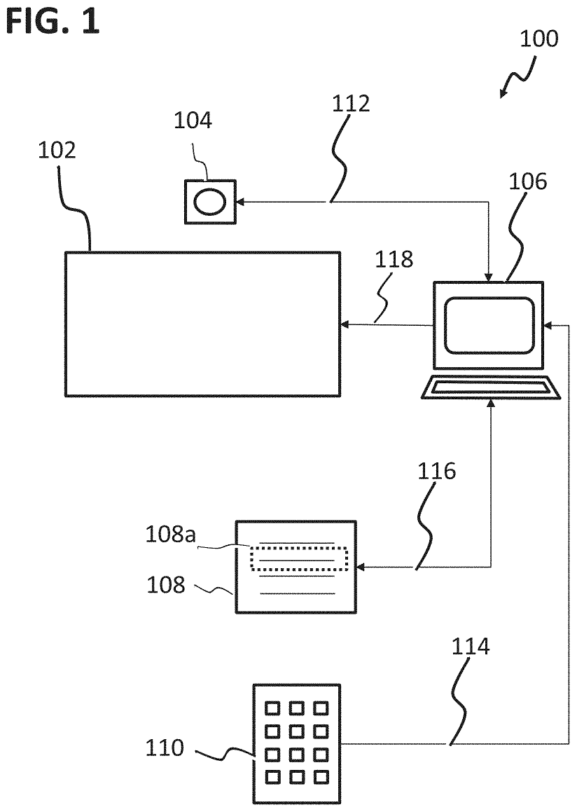

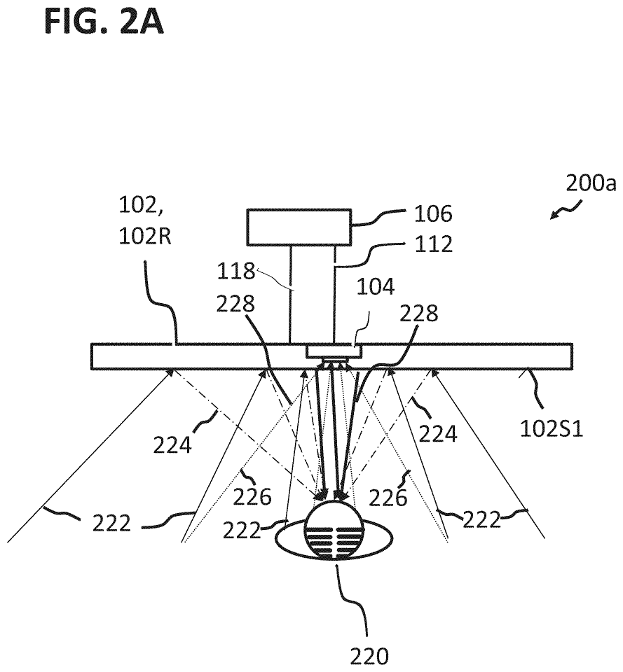

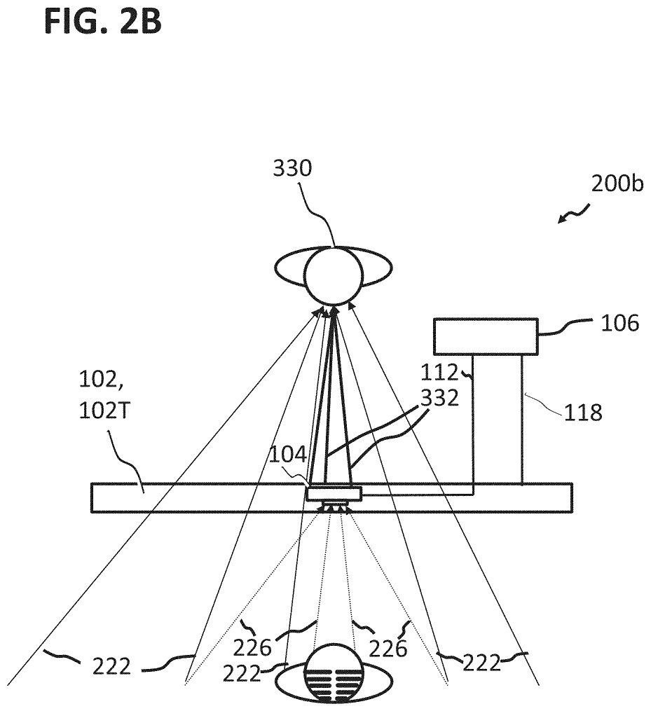

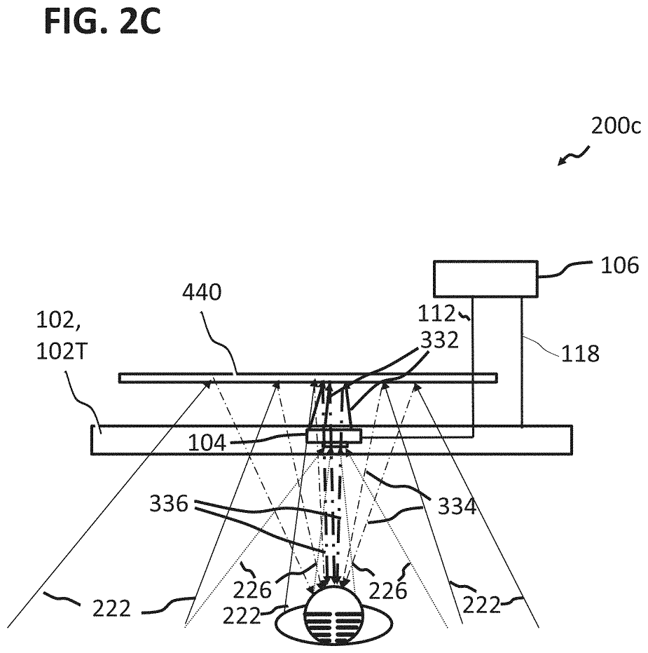

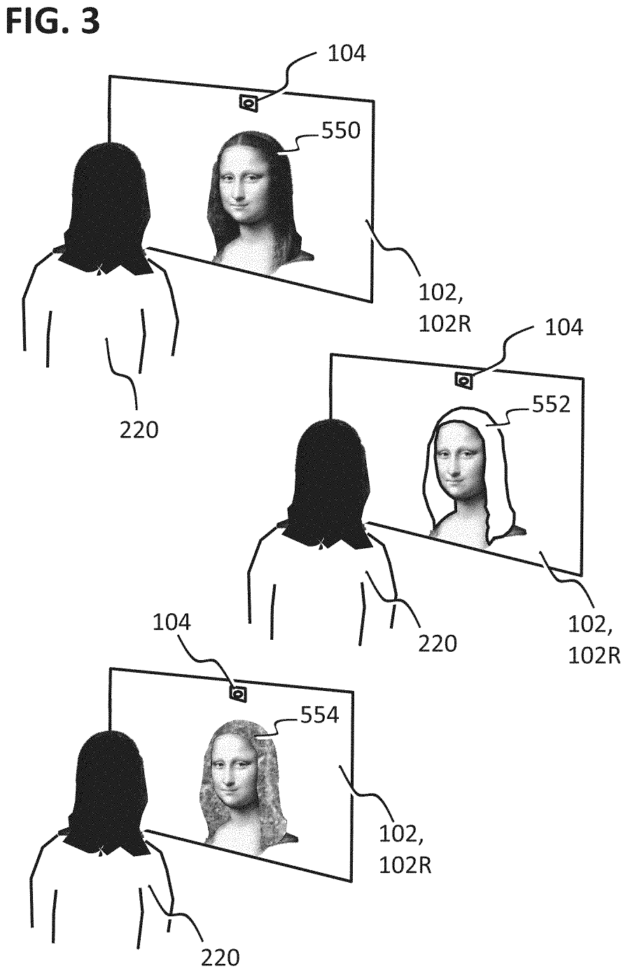

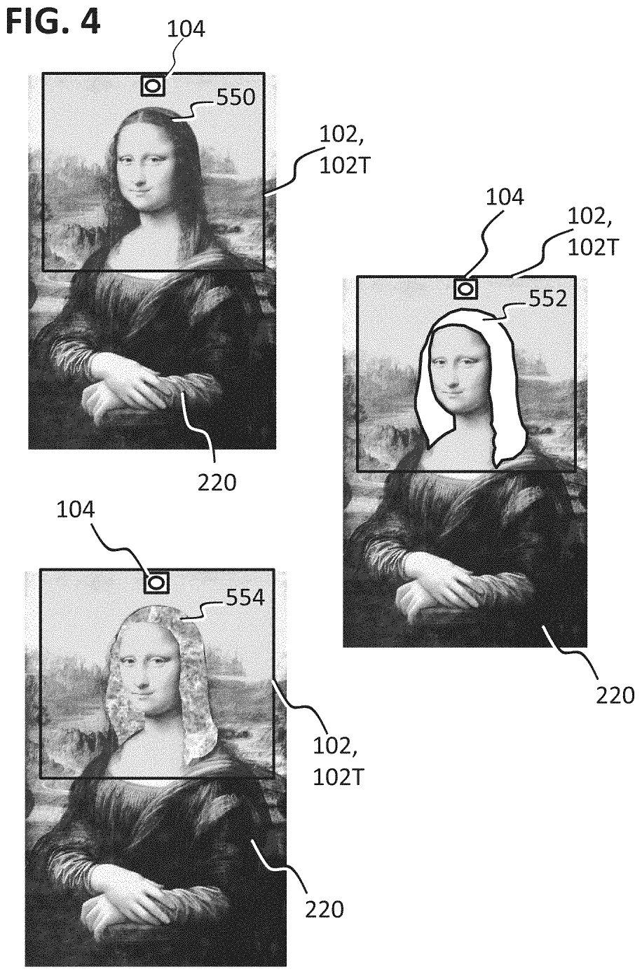

FIG. 1 shows a diagrammatic presentation 100 of a device for carrying out computer-aided hair color counseling in accordance with various exemplary embodiments, and FIG. 2A, FIG. 2B, FIG. 2C, FIG. 3 and FIG. 4 show graphical representations to illustrate a method for computer-aided hair color counseling in accordance with various exemplary embodiments.

In various exemplary embodiments, the device for carrying out the computer-aided hair color counseling may comprise a screen 102. The screen 102 may be what is known as an OLED screen. This should be understood to means that, in order to represent an image, a plurality of organic light emitting diodes (OLEDs, the acronym for “organic light emitting device”) are used.

In various exemplary embodiments, the screen 102 may have a response time of less than 1 second, for example less than about 0.1 seconds, for example less than about 10 ms, for example less than about 1 ms.

In various exemplary embodiments, the screen 102 may have a contrast ratio of at least about 4000:1, for example at least about 10000:1, for example at least about 50000:1, for example at least about 100000:1.

In various exemplary embodiments, the screen 102 may have a good screen resolution, for example a resolution of at least about 1920 by about 1080 picture elements, which is described as full HD resolution, or, for example, what is known as 4K resolution, which may have a resolution of about 4096×about 2160 picture elements (pixels).

In various exemplary embodiments, for a given color parameterization in a color space, for example NTSC, L*a*b*, CMYK or the like, the screen 102 may be capable of representing at least about 70% of the color space, for example at least about 80%, at least about 90%, for example approximately 100%.

In various exemplary embodiments, the screen 102 may be a reflecting screen. In this case, the screen 102 is also described as a (reflecting) screen 102R. The term “reflecting screen 102R” as used herein should be understood to mean a screen which has a first surface 102S1 which has a reflection ratio of at least about 75%, i.e. at least about 75% of the incident light is reflected at a wavelength which can be detected by the human eye. The first surface 102S1 may, for example, reflect at least about 80% of the light, for example at least about 85%.

In various exemplary embodiments, the screen 102 may be a light-transmitting screen. In this case, the screen 102 is also described as a (light-transmitting) screen 102T. The light-transmitting screen 102T may also be described as a partially transparent screen, shortened to “transparent screen”, even when the screen 102T has a transparency of less than about 100%. In various exemplary embodiments, the transparent screen 102T may have a transparency of more than about 10%, for example more than about 15%, for example more than about 25%, for example more than about 40%. With the light-transmitting screen 102T, the first surface 102S1 may be configured in a manner such that it reflects as little light as possible, for example so that it has a reflection ratio of at most about 20%, for example at most about 15%, for example at most about 10%, for example at most about 5%.

In various exemplary embodiments, for example instead of the light-transmitting screen, a one-way mirror may be used in combination with a (for example conventional) camera, wherein a (partial) image projected from the camera onto the one-way mirror can overlay an image transmitted by the one-way mirror of a background. In this manner, for example, the (for example recolored) hair region may be provided on the image projected onto the one-way mirror and the transmitted image for the observer can be shown to a user 220.

In various exemplary embodiments, the device 100 for carrying out the computer-aided hair color counseling may comprise at least one camera 104.

In various exemplary embodiments, the camera 104 may be configured to record a digital image of hair of the user 220 and additional objects. The additional objects may, for example, comprise a face and/or a body of the user 220, and/or other items, people, animals or the like. A region of the digital image in which the hair of the user 220 is depicted can be described as the hair region area.

In other words, the camera 104 may be configured to make a digital image of a user 220 and their surroundings in a manner such that in the digital image, at least a portion of the hair of the user 220 is depicted.

In addition to the hair region area, the digital image may comprise object regions in which the additional objects are depicted, for example an eyebrow region, a skin region which, for example, may comprise a region of the facial skin and/or of the neck skin, as well as the background region, etc.

In various exemplary embodiments, the at least one camera 104 may comprise a video camera, i.e. a camera 104 which may be configured to record a plurality of individual images in a sequence in time. In accordance with various exemplary embodiments, the at least one camera 104 may comprise a camera that can record individual images.

In various exemplary embodiments, the at least one camera may, for example, comprise an Intel Live Camera.

In particular, the camera may be what is known as a “time of flight” camera (TOF camera) which can determine a distance to a recorded object using a time of flight method (the function of a TOF camera is explained in the Wikipedia article “TOF camera” in the version dated 25 Jul. 2016 (URL: https://en.wikipedia.org/wiki/Time-of-flight camera).

In various exemplary embodiments, the TOF camera may be coupled with or be a conventional camera in order to record a digital image and at the same time to obtain spatial information.

This means that it may be possible to obtain distance information regarding the portion of the hair and the user 220. This could facilitate the computer-aided simulation of the hair coloration.

In various exemplary embodiments, the at least one camera 104 may be configured in a manner such that its at least one optical axis is perpendicular or substantially perpendicular to the first surface 102S1 of the screen facing the user 220.

In various exemplary embodiments, the at least one camera 104 may be disposed close to a vertical central axis of the screen 102. The at least one camera 104 may, for example, be at a distance of at most about 30 cm from the central axis, for example at most about 20 cm, for example at most about 10 cm, for example on the central axis.

In accordance with various exemplary embodiments, an essentially central positioning of the camera 104 with an optical axis of the camera 104 essentially perpendicular to the first surface 102S1 of the screen 102 makes it possible for a hair region area 554, also known as the hair projection region 554, projected by the screen 102, to cover a hair transmission/reflection region 550 which is reflected from the screen 102R or transmitted by the light-transmitting screen 102T (the screen region described for both types of screen—light-transmitting and reflecting—in general as the hair transmission/reflection region 550 may be described as the hair transmission region 550 when the screen is the light-transmitting screen 102T, and as the hair reflection region 550 when the screen is the reflecting screen 102R). When using the method, the hair transmission/reflection region 550 is overlaid with the hair projection region 554. In various exemplary embodiments, furthermore, the user 220 may be positioned such that the hair projection region 554 covers the hair transmission/reflection region 550, for example from the point of view of the user 220 or from the point of view of the observer 330.

In various exemplary embodiments, the camera 104 may be integrated into the screen 102. As an example, the camera 104 may be disposed in one region of the surface 102S1 in the place of image elements of the screen 102.

In various exemplary embodiments, in the case of the light-transmitting screen 102T, the camera 104 may be disposed behind the screen 102T from the user's point of view 220, so that the camera 104 can record the user 220 through the screen 102T. A change in the color and/or brightness information from light which reaches the camera 104 through the screen 102T as a result of passing through the screen 102T may be taken into account by a computer 106 when processing the image (see below). The arrangement of the camera 104 in or behind the screen 102 can allow essentially central positioning of the camera 104 both as regards the horizontal as well as the vertical extent of the screen 102.

In various exemplary embodiments, the camera 104, the screen 102 and the user 220 may be disposed relative to each other and orientated in a manner such that the alignment of the hair projection region 554 (in which the hair is projected) of the light-transmitting or reflecting screen 102T, 102S is carried out. In this regard, alignment may be carried out in a manner such that for the observer of the screen (who, for example could be the user 220, as shown, for example, in FIG. 2A and FIG. 2B, or the additional person, as can be seen in FIG. 2B), a combination of the objects transmitted or reflected by the screen 102T or 102S with the hair projection region 554 occurs, in which the hair projection region 554 essentially covers a hair transmission/reflection region 550 in which, to the observer 220, 330, the hair of the user 220 is transmitted or reflected.

In various exemplary embodiments, therefore, without additional computer time, for example after setting up a hair color counseling site once with the screen 102, the camera 104 and a fixed (for example seating) position for the user 220, a method for computer-aided hair color counseling can be carried out which provides the observer (for example the user 220) with a reflected or light-transmitted image of the user 220 with a projection of the new color of the hair, wherein the hair is projected at the position of the screen 102 at which to the observer, the reflected or transmitted hair of the user 220 would appear without the projection.

In accordance with various exemplary embodiments, the at least one camera 104 may comprise a 3D camera which may be set up to provide three-dimensional information as regards the user (and possibly the additional objects), for example as regards a distance between the camera 104 and the user 220. As an example, the at least one camera 104 may be a time of flight camera (see above) or a stereo camera which may have two cameras or at least two camera lenses so that two separate images can be recorded with a spatial distance between the cameras or the lenses. In various exemplary embodiments, the at least one camera 104, for example in addition to the camera 104 for recording the digital image of the user 220, may have a triangulation system, in which a light source emits a specific pattern, for example onto the user 220, which can be recorded by the camera from another viewing angle so that a calculation of a distance can be made on the basis of distortion of the specific pattern. As an alternative or in addition, other or further known systems for providing three-dimensional information may be used, for example cameras which exploit the time of flight of the light in order to calculate distances.

In a case in which the at least one camera 104 comprises the two 3D cameras, the two 3D cameras may be disposed at a distance from each other that is suitable for recording 3D images, for example in a manner such that the camera 104 which is further from the central axis is disposed at a distance of at most about 30 cm from the central axis, for example at most about 20 cm, for example at most about 10 cm.

The two cameras 104 may, for example, be symmetrically disposed about the central axis.

In various exemplary embodiments, the spatial information which is provided by the 3D camera is used to align a hair projection region of the light-transmitting or reflecting screen. In this regard, the alignment may be carried out by producing, for an observer of the screen (who might, for example, be the user 220 or the additional person 330), a combination of the objects transmitted or reflected by the screen 102T or 102S with the hair projection region, in which the hair projection region essentially covers a hair transmission/reflection region 550 in which the transmitted or reflected hair of the user would appear.

In various exemplary embodiments, the additional objects may comprise a positional reference, for example at least one object, for example a plurality of objects, which may be disposed at a predetermined, known position. The positional reference/s may be suitable for automatic identification in the digital image, for example by employing software; examples are objects with a marked, for example high-contrast structure. As an example, four objects may be disposed as a positional reference which mark corners of a region which may be scaled and orientated such that it could fill the whole screen 102.

In various exemplary embodiments, the known position of the positional reference and an image position of the positional reference at which the positional reference is depicted in the digital image, for example determined by employing computer software, may be used to carry out an alignment of the hair projection region 554 of the light-transmitting or reflecting screen 102. In this regard, alignment may be carried out wherein, for an observer of the screen (who may, for example, be the user 220, as shown, for example, in FIG. 2A and FIG. 2C, or an additional person, as can be seen in FIG. 2B), a combination of the objects transmitted or reflected by the screen with the hair projection region 554 is produced, in which the hair projection region 554 essentially covers the hair transmission/reflection region 550 in which the hair of the user would appear to the observer 330 to have been transmitted or reflected.

In various exemplary embodiments, for example in the case in which the hair projection region 554 does not automatically cover the hair transmission/reflection region 550 by employing the arrangement of the user 220, the screen 102 and the camera 104, a data processing device 106 may be used in order to determine a shape of the hair transmission/reflection region 550 (for example by incorporating known (spatial) coordinates and angles of orientation of the user 220, the screen 102, the camera 104, optionally the positional reference and optionally of the observer 330) and then to align a shape of the hair projection region 554 by computer. Alignment of the hair projection region 554 may, for example, comprise displacing the hair projection region 554 on the screen 102, for example in the horizontal and/or vertical direction with respect to the screen 102. Furthermore, the alignment may, for example, comprise shrinking the hair projection region 554 in the horizontal and/or vertical direction and/or rotating the hair projection region 554 clockwise or counter-clockwise. In various exemplary embodiments, a plurality of the alignment measures may be combined.

In various exemplary embodiments, the camera 104 may be set up to identify a hair coloring agent, for example on the basis of packaging. The camera 104 may, for example, record a 1-dimensional or 2-dimensional barcode, for example a QR code which can be allocated to the hair coloring agent.

Alternatively or in addition, the device for carrying out the computer-aided hair color counseling in accordance with various exemplary embodiments may comprise a sensor to identify the hair coloring agent, for example a further camera, a barcode scanner, a QR code scanner or a RFID chip sensor.

In various exemplary embodiments, the device for carrying out the computer-aided hair color counseling may comprise the data processing device 106, for example a computer, a tablet, or any other data processing device, which is capable of carrying out the method for the computer-aided hair color counseling in accordance with various exemplary embodiments. For simplification, the data processing device 106 will also be described herein as a computer 106.

In various exemplary embodiments, the device for carrying out the computer-aided hair color counseling may comprise a first data connection 112 between the computer 106 and the camera 104. By employing the first data connection 112, data can be transmitted from the computer 106 to the camera 104, for example in order to control the camera 104 using software which may be conventional software. Furthermore, by employing the first data connection 112, data, for example the digital image/s recorded by the camera 104, may be transmitted to the computer 106.

Although the method here is in part illustrated using a single digital image, it should be understood that the method may be used for a plurality of images, for example a sequence of digital images, for example a video.

The computer 106 may be set up to process the image received from the camera 104 using image processing software, for example in order to identify the hair region area in the received image in a known manner. In FIG. 3 and FIG. 4, the hair region area is only shown as the area 552 for the case in which the hair region area as the presented hair projection region 554 covers the hair transmission/reflection region 550 without further manipulation. In other cases, the hair region area (not shown) may have another shape, size and/or position and be modified using software supplied to the data processing device 106 in a manner such that as the hair projection region 554, it covers the hair transmission/reflection region. This covering region is shown as region 552 in FIG. 3 and FIG. 4.

In various exemplary embodiments, the device for carrying out the computer-aided hair color counseling 100 may comprise a second data connection 118 between the computer 106 and the screen 102.

By employing the second data connection 118, control signals can be transmitted from the computer 106 to the screen 102 in conventional manner. As an example, the computer 106 may provide information via the second data connection 118 to the screen 102 regarding which position and what color should be used to display the hair projection region 554.

In various exemplary embodiments, the device for carrying out the computer-aided hair color counseling 100 may comprise a database 108. The database 108 may comprise hair coloring product data with a plurality of hair coloring products to which respectively, for example, a hair color, a product name, a barcode, a QR code and other information such as, for example grey coverage, a chemical composition, etc, may be allocated. Furthermore, the database may, for example, comprise customer data which, for a majority of customers, comprises hair coloring products which have already been used and/or stored, for example hair coloring products which can be stored in the hair coloring product database.

In various exemplary embodiments, the device 100 for carrying out the computer-aided hair color counseling 100 may comprise a third data connection 116 between the computer 106 and the database 108.

By employing the third data connection 116, data may be exchanged between the computer 106 and the database 108, for example in a conventional manner. In various exemplary embodiments, the database 108 may be a part of the computer 106; as an example, the database 108 may be stored in the memory of the data processing device 106. In that case, the second data connection 116 may be a connection between the memory and, for example, a processor of the computer 106. In various exemplary embodiments, the database 108 may be an external database.

By employing the third data connection 116, all or part of the stored data can be supplied to the computer 106 from the database 108 and/or, for example, a query can be transmitted from the computer 105 to the database 108.

In various exemplary embodiments, the device 100 for carrying out the computer-aided hair color counseling may comprise a control panel 110 and a data connection 114 which can connect the control panel 114 to the computer 106.

In various exemplary embodiments, by employing the control panel, the data processing device 106 (for example start/stop of the method, setting method parameters) and/or at least one device connected to the data processing device 106 may be operated, for example the camera 104 (for example zoom, focus, angular position (i.e. the angle of the optical axis and/or spatial position), the screen (for example brightness, color), the database 108 (from which an input 108 may be selected by employing the control panel 114, for example when a plurality of the selectable hair colors stored in the database 108 are presented to the user 202, for example on the screen 102 or on an additional screen) and/or an optional additional sensor (not shown, for example a scanner for barcodes and/or QR codes and/or a RFID sensor which can be activated/deactivated using the control panel 114).

In various exemplary embodiments, the control panel 114 may, for example, comprise a special or normal keypad, a computer mouse, a joystick, a touch-sensitive surface of the screen 102 or another suitable control panel.

In various exemplary embodiments, the device 100 may comprise more than one control panel, for example to directly control one of the components, for example the camera 104 or the screen 102.

In various exemplary embodiments, it may be sufficient for the user 220 to carry out the setting of the components of the device 100, for example the camera 104, the screen 102, just once and to select a hair color (for example a plurality of hair colors which can be displayed one after the other). Alternatively or in addition, in various exemplary embodiments, a further person, for example personnel in a store in which the device 100 is operated, can undertake the setting-up, for example using the control panel. Alternatively or in addition, furthermore, software may be used in order to select the new hair color automatically, for example with the aid of an original hair color, color of clothing or skin color of the user 220, or, for example, on the basis of previous purchases by the user 220 for example also from online stores.

In various exemplary embodiments, after successfully setting it up, for example by using the control panel 114, the user can then concentrate on observing the result.

In various exemplary embodiments, the screen 102 may furthermore be used to project the hair in the original hair color in the hair projection region 554, for example prior to projecting the hair in the new hair color. This enables the user 220 to check a color and brightness reproduction by the hair projection region 554 and optionally to undertake correction of the color and/or brightness. The color and/or brightness correction which is undertaken may also be undertaken upon projection of the color result in the hair projection region 554.

Alternatively or in addition, furthermore, in various exemplary embodiments, a color and/or brightness reference may be provided. The color and/or brightness reference may be used in order to correct color and/or brightness values for the plurality of image elements which are provided to the computer 106 from the camera 104 in the form of the digital image, such that for the image elements in which the color and/or brightness reference is shown, the correctly allocated color and/or brightness values can be provided.

FIG. 2A diagrammatically shows, in a view 200a, a device in accordance with various exemplary embodiments for carrying out the method for computer-aided color counseling in accordance with various exemplary embodiments.

In view 200a, the reflecting screen 102R is used as the screen 102.

In various exemplary embodiments, light 222 which is emitted from the face, body and hair of the user 220, and optionally from other objects, for example items and/or reference objects, is reflected from the screen 102R to the user 220. The reflected light which reaches the eyes of the user 220 is shown in FIG. 2A as reflected light 224. The reflection from parts of the body and optionally from other surrounding objects forms for the user 220, who here may also be the observer, for example, a first component of a composite image which presents a presentation of themselves with a new hair color. Even their hair is reflected to the user 220. It appears to the user 220 in a hair reflection region 550.

For a second component, the camera 104 is used which receives light 226 from the user 220 (in particular from their hair) and from at least a portion of the body of the user 220, for example the face, neck etc, and possibly from other objects and forms a digital image therefrom which is transmitted to the computer 106 via the data connection 112.

In the digital image, the hair region area can be identified in a conventional manner using the computer 106. The hair region area, as described above, if necessary, can be aligned in a manner such that a region 552 is produced in which the hair reflection region 550 is covered by the hair projection region 554. The shape, size, position and angular position of the region 552 can coincide or essentially coincide with that of the hair reflection region 550 and of the hair projection region 554.

In various exemplary embodiments, in the hair projection region 554, the hair of the user 220 can be projected in a new hair color. The new hair color may, for example, be selected by the user, for example via the input device 110 or by employing a sensor, for example as described above, for example as the hair coloring product and/or as the color formulation.

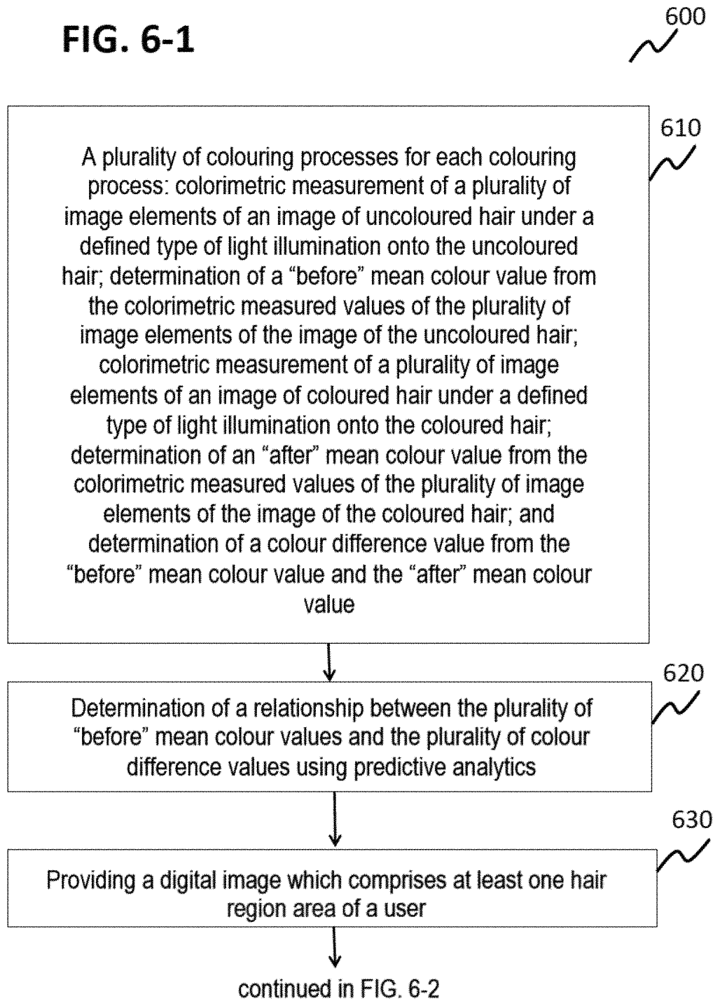

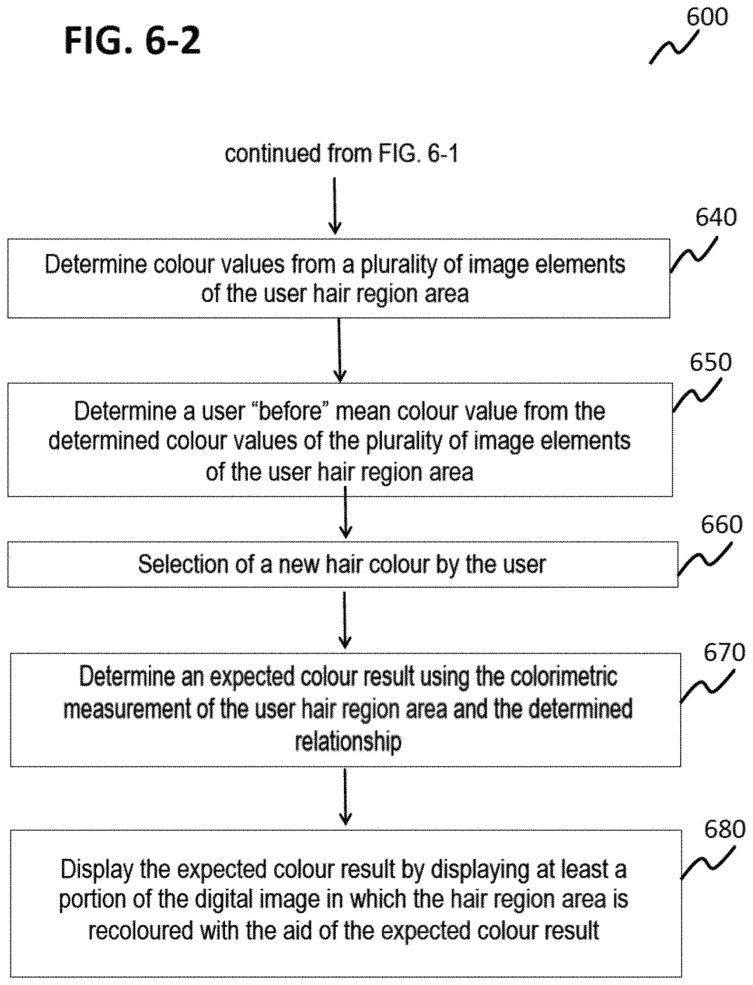

Colors which are to be displayed for the selected hair color on the screen 102R in the hair projection region 554, i.e. color and possibly brightness values which are assigned to the image elements in the hair projection region, may be identified in various exemplary embodiments in accordance with the method described herein, for example in connection with FIG. 6, for presenting a hair color result and then transmitted via the data connection 118 to the screen 102R and in the hair projection region 554 via the screen 102R. This allows for easy calculation of the color values to be computed as a sum of the determined color value for each image element and a color difference value which is the same for all image elements by employing the computer 106, and thus a rapid sequence when showing a plurality of images, for example when carrying out the method for hair color counseling in a quasi-real time mode in which the camera 104 may, for example, be a video camera.

In various exemplary embodiments, the colors may be determined in a known manner.

In various exemplary embodiments, the hair projection region 554 projected by the screen 102R, shown in FIG. 2A as light 228, which is emitted by the screen 102R and which reaches the eyes of the user 220, may be the second component of the composite image.

The method is further illustrated for the reflecting screen 102R in FIG. 3. In the upper view, the reflecting screen 102R, the camera 104, the user 220 (from behind) and their reflection which is reflected by the screen can be seen. In this regard, the hair is reflected in a hair reflection region 550.

A central view is only for illustration and thus would not be seen when carrying out the method. Here, the region 552 is marked in which the hair reflection region 550 and the hair projection region 554 (which in one arrangement of the camera 104 as shown has been aligned by the computer 106 significantly above the centre of the screen 102R in order to cover the hair reflection region 550) overlap each other.

In a lower view, the new hair color selected by the user 220 is projected in the hair projection region 554. In this regard, the hair projection region 554 may be recolored by employing the method for presenting a hair color result described herein, or by employing other known methods, for example so that the hair projection region 554 is not uniformly colored in the new hair color, but, for example, is presented as lighter regions which are brightened by light and/or wherein regions in shadow are darker, wherein a distribution of light and shadow may correspond to the original distribution in the hair reflection region 550.

By employing the projection of the hair projection region 554, a reflection of the hair in the hair reflection region 550 may be transmitted so that the user essentially only perceives the projected light in the hair projection region 554.

In a view 200b, FIG. 2B diagrammatically shows a device in accordance with various exemplary embodiments when it is carrying out the method for computer-aided color counseling in accordance with various exemplary embodiments.

In the view 200b, the light-transmitting screen 102T is used as the screen 102.

In various exemplary embodiments, light 222 emitted by the user 220, for example the face, body and hair, and possibly from other objects, for example items and/or reference objects, is radiated from the screen 102R to the observer 330 and at least partially transmitted by the screen 102T. The transmission from parts of the body of the user 220 and possibly from other objects surrounding the user 220 form, for the observer 330, a first component of a composite image which presents them with a presentation of the user with a new hair color. Light from the hair is also transmitted to the observer. It appears to the observer in a hair transmission region 550.

For a second component, the camera 104 is used in combination with the computer 106 as described in connection with FIG. 2B, in order to project the hair projection region 554 with the new hair color, for example at least in the direction of the observer 330.

The hair projection region 554 projected by the screen 102R, shown in FIG. 2B as the light 332, which is emitted by the screen 102R and which reaches the eyes of the observer 330 may in various exemplary embodiments be the second component of the composite image.

The method is further illustrated for the light-transmitting screen 102T in FIG. 4. The top view shows the light-transmitting screen 102T, the camera 104, the user 220 (from the front, for example hands, arms and upper body) and their image transmitted by the screen (in a region framed by the frame of the screen). In this manner, light is transmitted from the hair in a hair transmission region 550.

A central view is only for the purposes of illustration, and thus would not be seen when carrying out the method. Here, the region 552 is marked where the hair transmission region 550 and the hair projection region 554 (which in one arrangement of the camera 104 as shown, significantly above the centre of the screen 102R, has been aligned using the computer 106, in order to cover the hair transmission region 550) overlap each other.

In a bottom view, the new hair color selected by the user 220 is shown in the hair projection region 554 as described above in connection with FIG. 2A, with the difference that the projection may be made at least in the direction of the observer 330.

By employing the projection of the hair projection region 554, light can be transmitted from the hair in the hair transmission region 550, so that the user essentially only sees the projected light in the hair projection region 554.

FIG. 2C diagrammatically shows, in a view 200c, a device in accordance with various exemplary embodiments when carrying out the method for computer-aided color counseling in accordance with various exemplary embodiments.

In view 200c, the light-transmitting screen 102T is used as the screen 102.

Here, the method for hair color counseling and the device for carrying out the method essentially corresponds to that described above in connection with FIG. 2C and FIG. 4, with the exception that the device has an additional mirror 440 which is disposed behind the screen 102T from the user's point of view, so the user can observe the combined image in the mirror 440 which the observer 330 can observe in FIG. 2B.

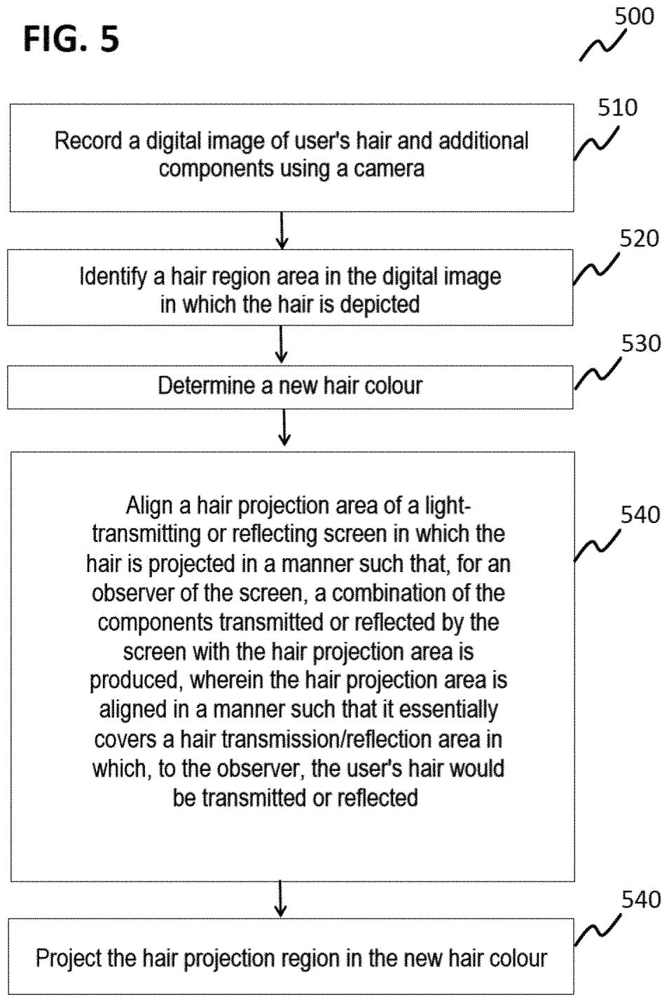

FIG. 5 shows a flow chart 500 which represents a method for computer-aided hair color counseling in accordance with various exemplary embodiments.

The method may comprise recording a digital image of hair of a user and additional objects using a camera (in 510), identifying a hair region area in which the hair is depicted, in the digital image (in 520), aligning a hair projection region in which the hair is projected, of a light-transmitting or reflecting screen in a manner such that, for an observer of the screen, a combination of the objects transmitted or reflected by the screen is produced with the hair projection region, wherein the hair projection region is aligned in a manner such that it essentially covers the hair transmission/reflection region in which, to the observer, the hair of the user would be transmitted or reflected (in 540), and projecting the hair projection region in the new hair color (in 550).

FIG. 6 shows a flow chart 600 which represents a method for computer-aided hair color counseling in accordance with various exemplary embodiments.

The method may comprise a plurality of coloring processes for each coloring process: colorimetric measurement of a plurality of image elements of an image of uncolored hair under a defined type of light illumination onto the uncolored hair, determination of a “before” mean color value from the colorimetric measured values of the plurality of image elements of the image of the uncolored hair; colorimetric measurement of a plurality of image elements of an image of colored hair under a defined type of light illumination onto the colored hair, determination of an “after” mean color value from the colorimetric measured values of the plurality of image elements of the image of the colored hair; and determination of a color difference value from the “before” mean color value and the “after” mean color value incorporating correction factors for very dark or very light image regions (in 610), determination of a relationship between the plurality of “before” mean color values and the plurality of color difference values using predictive analytics (in 620), providing a digital image which comprises at least one hair region area of a user (in 630), determining color values from a plurality of image elements of the user hair region area (in 640), determining a user “before” mean color value from the determined color values from the plurality of image elements of the user hair region area (in 650), selection of a new hair color by the user (in 660), determining an expected color result using the determined color values from the user hair region area and the determined relationship (in 660), and displaying the expected color result by displaying the digital image in which the hair region area is recolored with the aid of the expected color result (in 670).

In various exemplary embodiments, methods may be used from the field of predictive analytics (also known as “big data”), “data mining” or “machine learning”, so that, despite many influencing parameters possibly being in the hair color result, a precise computation of a hair color result can be produced, for example a color difference value based, inter alia, on a basic hair color and on a mean value for the basic hair color determined therefrom (also known as the “before” mean color value).

In accordance with various exemplary embodiments, it is possible, using test coloring, to provide a data set (also known as hair color data) which comprises a plurality of color requirement parameters (including at least the basic hair color and the color formulation used) and color result parameters (at least one hair color obtained following coloring and a mean value determined therefrom (also known as the “after” mean color value).

Furthermore, the data set may comprise other color requirement parameters, for example previous damage to the hair, a level of greying of the hair, and/or other color requirement parameters.

In various exemplary embodiments, a color space, on which the color information is based (for example the hair color information for the colored hair or the hair prior to coloring, also known as the basic hair color), or in which the color information is presented (for example when a hair color is presented, see below) can be generated in a manner such that a determined or presented color is independent of a medium through which the color is determined or presented (for example color measurement device, screen, printer, scanner, human eye, etc). The color space may, for example, be a L*a*b* color space, and the color information may, for example be the shade parameterized using a* and b*. The consistent presentation in the medium-independent color space may, for example, make it possible to present an expected color result which is close to reality, for example, in that the observer of the colored hair will perceive the same color when presented with the expected color result as, for example, on a printed package, a display on a computer screen, or the like.

In various exemplary embodiments, the color space may comprise a CIELUV or a /1/2/3/- color space which is more suitable for an additive light color than, for example, the L*a*b* color space.

In various exemplary embodiments, the at least one color result parameter may furthermore comprise other properties of the colored hair color, for example color fastness, fastness to washing or the ability to cover grey.

In accordance with various exemplary embodiments, the data set may be used as the basis for using a predictive analytics method.

As an example, the color requirement parameters or portion of the color requirement parameters and the color result parameters associated therewith or a portion of the color result parameters may be used to produce a model which describes the data set as closely as possible.

In various exemplary embodiments, the measurement data of the data set, i.e. the measured details of the hair color data, can describe the properties of the hair color obtained by coloration (for example L*_{mean,after}, a*_{mean,after}, b*_{mean,after} as a mean value of a colorimetric measurement carried out, for example, on a colored strand of hair, and optional additional color result parameters such as, for example, fastness to washing, light fastness, grey coverage or the like), may be dependent variables. By employing a complex mathematical model which can be generated by employing a predictive analytics method, the dependency of the dependent variables on the independent variables (for example L*_{mean,before}, a*_{mean,before}, b*_{mean,before}) can be modelled as a mean value of a colorimetric measurement carried out, for example, on an uncolored strand of hair, a color difference value ΔLab=(L*_{mean,after}, a*_{mean,after}, b*_{mittel,after})−(L*_{mean,before}, a*_{mean,before}, b*_{mean,before}) and optional additional color requirement parameters such as, for example, a degree of damage to the hair, etc). This means that by using the predictive analytics method, a relationship between the independent and the dependent variables (in other words between the color requirement parameters and the color result parameters) can be determined. For the color difference value, this may, for example, be expressed as:

ΔLab=f(L*_{mean,before},a*_{mean,before}+b*_{mean,before})

wherein ΔLab represents the color difference value, L*_{mean,before}, a*_{mean,before}, b*_{mean,before} represents the mean color value prior to coloring. In this regard, the function may or may not be known analytically. If no analytical function is known, the values for the dependent variables (the color result parameters) may also be computed using numerical algorithms.

In various exemplary embodiments, the independent variables (the color requirement parameters) may be properties which influence the color result, for example in addition to the basic hair color (for example as a mean value), a color formulation, a degree of damage and/or a level of greying of the hair, or the like.

In various exemplary embodiments, a model may be produced using predictive analytics which, for the given color requirement parameters (independent variables, see above for examples), can predict the color result parameter (dependent variables, see above for examples) as precisely as possible.

In various exemplary embodiments, by using predictive analytics, a continuous model of the color requirement parameters and of the color result parameters can be produced, so that it is possible for a value for a color requirement parameter or a combination of values for a plurality of color requirement parameters, to which none of the relevant experimental values or combinations of values correspond, to be determined with the aid of the model of a value for a color result parameter.

In general, predictive analytics can be described as extracting information from big data and producing a model from this data which, even for values which do not form part of the data set, enables predictions to be made. When using a predictive analytics method, typically, a portion of the data set is used as a training data set (also known as a training set or training data). With the aid of this training data set, one or more models can be produced which then can be tested with the aid of the data which do not form part of the training data set, with the aid of the data as a whole, or with the aid of a specially selected portion of the data.

In order to evaluate the model, i.e. to determine the level of alignment, for example, a coefficient of determination R², a mean absolute error, a mean quadratic error, a standard deviation and/or a mean deviation are employed.

The coefficient of determination R² may correspond to a linear regression model of a quadratic correlation coefficient. It may be defined differently for another model (another relationship).

When modelling using predictive analytics, in accordance with various exemplary embodiments, different functions of methods may be employed. In a simple case, a multiple linear regression may be used, for example. Better results can typically be obtained using polynomial regressions, neural networks, support vector machines, decision trees (for example tree ensembles) or the like.

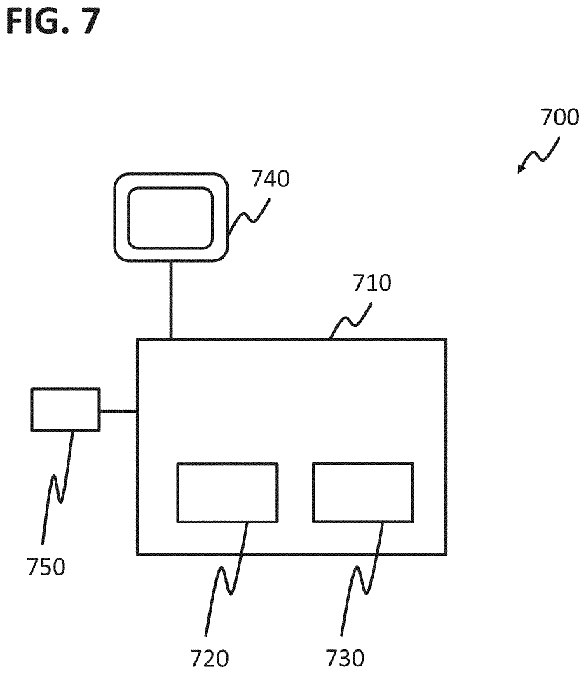

In various exemplary embodiments, the described method for presenting a hair color result may be carried out using a data processing device, for example a data processing device as described in conjunction with FIG. 7.

In various exemplary embodiments, for example when the color result parameter to be output comprises a hair color, the color may also be parameterized for outputting in a medium-independent color space, for example the L*a*b* color space. This means that, for example, the aforementioned determined expected color result which may, for example, be displayed on a screen or printed out (for example on packaging of a coloring product), essentially appears as it would after coloring in reality. Insofar as the output device demands another parameterization of the color, the determined color may be transformed from one color space into another.

In various exemplary embodiments, the method for presenting a hair color result may furthermore comprise providing a digital image which comprises at least one hair region area of a user. The hair region area may, for example, be a view of a complete hairstyle.

In accordance with various exemplary embodiments, by employing known methods, a user hair region area, i.e. an area in which hair of the user is depicted, may be determined. The known method may, for example, comprise a cropping procedure as might be usual, for example, in Photoshop and other software packages.

In accordance with various exemplary embodiments, using the data processing device, a plurality of image elements of the user hair region area may be identified in the digital image.

From the determined color values of the plurality of image elements of the user hair region area, a before user mean color value may be determined, for example calculated from means, for example arithmetic means, weighted means, median formation or the like.

In various exemplary embodiments, the user may select a new hair color, for example as a product, a color formulation, a sample photo or the like. The user may make their choice using an input device (see FIG. 7 and the associated description).

In various exemplary embodiments, an expected color result may be determined with the aid of the user “before” mean color value and the determined relationship. In other words, with the aid of the determined relationship, starting from the user “before” mean color value and the selected hair color, an expected user “after” mean color value (and as a difference between the user “after” mean color value and the user “before” mean color value) can be determined from the color difference value. By adding the color difference value to each color value of the plurality of image elements of the user hair region area, in accordance with various exemplary embodiments, the expected color result can be determined. In other words, the hair region area can be recolored with the new hair color by recoloring the plurality of image elements of the user hair region area by adding the color difference value to the determined color value for each image element of the plurality of image elements of the user hair region area.

Put yet another way, a correct L*a*b* value can be allocated to n image elements (also termed pixels) of the user hair region area, L_{i,before}, a_{i,before}, b_{i,before} for i=1, . . . , n; a mean value is determined therefrom, using the relationship; an expected color difference value (also known as the color displacement vector) ΔLab is determined; and this is added to each color value for the n image elements:

L_{i,after},a_{i,after},b_{i,after}=L_{i,before},a_{i,before},b_{i,before}+ΔLab

To a first approximation, a realistic color value after coloring can therefore be obtained for each individual image element of the user hair region area, for example a complete hairstyle.

In various exemplary embodiments, for example when the image comprises one or more image elements with a very dark or very light color value, so that the addition would fall outside a permissible space for a color parameter (for example for L*a*b* outside L: 0-100, a: −170 to +100 and b: −100 to +150), correction factors may be applied so that the permissible parameter space is not exceeded.

In various exemplary embodiments, the expected color result can be presented by presenting the digital image in which the hair region area has been recolored with the aid of the expected color result, for example by employing a screen 740 as shown in FIG. 7.

In various exemplary embodiments, the method may be carried out as a part of the method for computer-aided hair color counseling described in conjunction with FIGS. 1 to 5. In this regard, the recolored hair region (i.e. only the recolored hair region) can then be projected by the screen 102.

FIG. 7 is a graphical presentation 700 of a data processing device 710 for carrying out a method for displaying a hair color result in accordance with various exemplary embodiments.

As an example, the data processing device 700 may be or comprise a PC, a laptop or any other data processing device which is suitable for carrying out the method for displaying a hair color result, i.e., for example, a sufficiently large memory and a sufficiently powerful processor. In various exemplary embodiments, the data processing device 700 may be the data processing device 106 of FIG. 1, FIG. 2A, FIG. 2B or FIG. 2C.

In various exemplary embodiments, the data processing device 700 may be a processor 720. The processor 720 may, for example, comprise a microprocessor of the data processing device 700 or such a microprocessor.

In various exemplary embodiments, the data processing device 700 may comprise a data storage device 730. The data storage device may be an internal or external memory 730 of one of the said data processing devices 700 or such a memory 730. The memory 700 may be configured to store data which are stored and/or called up when carrying out the method for displaying a hair color result, for example the hair color data. In various exemplary embodiments, the data storage device 730 may be the memory 108 of FIG. 1.

In various exemplary embodiments, the data processing device 700 may comprise a display device 740. The display device 740 may, for example, be a screen of a PC, a laptop or any other data processing device 700. The display device may, for example, be used in order to display results of the method for presenting a hair color result, to interrogate parameters for carrying out the method, or the like. In various exemplary embodiments, the display device 740 may be the screen 102 from FIG. 1 to FIG. 4.

In various exemplary embodiments, the data processing device 700 may be an input device 750 for providing information to the data processing device 700, for example a keypad, a mouse, a touch-sensitive surface of the display device 740, or the like. In various exemplary embodiments, the input device 750 may be the control panel 110 from FIG. 1.

In accordance with a first exemplary embodiment, a method for computer-aided hair color counseling may comprise:

recording a digital image of hair of a user and additional objects by employing a camera;
identifying a hair region area in the digital image in which the hair is depicted;
identifying a new hair color;
aligning a hair projection region in which the hair is projected, of a transparent or reflecting screen or a system of screen and one-way mirror in a manner such that, to an observer of the screen, a combination of the objects transmitted or reflected by the screen is produced with the hair projection region, wherein the hair projection region is aligned in a manner such that it essentially covers a hair transmission/reflection region in which, to the observer, the transmitted or reflected user's hair would appear; and
projecting the hair projection region in the new hair color.

In accordance with a second exemplary embodiment, the method in accordance with the first exemplary embodiment may be configured in a manner such that recording the digital image, identifying the hair region area and presenting the hair region area colored with the new hair color can be repeated in a manner such that a quasi-real time presentation is produced.

In accordance with a third exemplary embodiment, the method in accordance with the first or second exemplary embodiment may be configured in a manner such that the identification of the new hair color may comprise selecting the new hair color from a plurality of selectable new hair colors provided by employing a database.

In accordance with a fourth exemplary embodiment, the method in accordance with one of the first to third exemplary embodiments may be configured in a manner such that the provision of the plurality of selectable new hair colors comprises displaying a selection menu on the screen.

In accordance with a fifth exemplary embodiment, the method in accordance with one of the first to fourth exemplary embodiments may be configured in a manner such that identifying the new hair color may comprise measuring a hair coloring product by employing a sensor.

In accordance with a sixth exemplary embodiment, the method in accordance with one of the first to fifth exemplary embodiments may be configured in a manner such that the user is also the observer.

In accordance with a seventh exemplary embodiment, the method in accordance with one of the first to sixth exemplary embodiments further comprises:

determining a color and/or brightness reference;
correcting the new hair color by employing the color and/or brightness reference.

In accordance with an eighth exemplary embodiment, the method in accordance with one of the first to seventh exemplary embodiments may be configured in a manner such that the alignment of the hair projection region may comprise arranging the user, the screen, the observer and the camera in a manner such that the hair projection region covers the hair transmission/reflection region when the hair projection region of the hair region area corresponds to a mirror image configuration of the whole digital image which fills the screen.

In accordance with a ninth exemplary embodiment, the method in accordance with one of the first to eighth exemplary embodiments may be configured in a manner such that the alignment of the hair projection region comprises adjusting a zoom factor of the camera.

In accordance with a tenth exemplary embodiment, the method in accordance with one of the first to ninth exemplary embodiments may be configured in a manner such that the alignment of the hair projection region may comprise recording a positional reference.

In accordance with an eleventh exemplary embodiment, the method in accordance with one of the first to tenth exemplary embodiments may be configured in a manner such that the alignment of the hair projection region may comprise recording spatial information regarding the user and the additional objects.

In accordance with a twelfth exemplary embodiment, the method in accordance with one of the first to tenth exemplary embodiments may further comprise:

projecting the hair projection region in an original hair color of the user.

In accordance with a thirteenth exemplary embodiment, the method in accordance with exemplary embodiment 12 may further comprise:

correcting the projection of the hair projection region by a color correction value, a brightness correction value or a color/brightness correction value with the aid of an overall impression of the combination of the objects transmitted or reflected by the screen with the hair projection region.

In accordance with a fourteenth exemplary embodiment, the method in accordance with one of the first to thirteenth exemplary embodiments may be configured in a manner such that the determination of the new hair color comprises the method in accordance with one of the exemplary embodiments 22 to 24.

In accordance with a fifteenth exemplary embodiment, the method in accordance with one of the first to fourteenth exemplary embodiments may further comprise:

presenting at least one colorant which is associated with the selectable new hair color.

In accordance with a sixteenth exemplary embodiment, a device for carrying out computer-aided hair color counseling may comprise:

at least one camera to record a digital image of hair of a user and additional objects;
a processor, wherein the processor is configured to identify the hair region area in the digital image of the user;
an input device for the user to select a new hair color; and
a light-transmitting or reflecting screen to project a hair projection region in the new hair color, wherein the hair projection region is aligned in a manner such that, for an observer of the screen, a combination of the objects transmitted or reflected by the screen is produced with the hair projection region, in which the hair projection region essentially covers the hair transmission/reflection region in which, to the observer, the transmitted or reflected hair of the user would appear.

In accordance with a seventeenth exemplary embodiment, the device in accordance with exemplary embodiment 16 may be configured in a manner such that the screen is an OLED screen.

In accordance with an eighteenth exemplary embodiment, the device in accordance with one of the exemplary embodiments 16 or 17 may be configured in a manner such that the at least one camera is disposed in a manner such that its at least one optical axis is perpendicular to a surface of the screen facing the user.

In accordance with a nineteenth exemplary embodiment, the device in accordance with one of the exemplary embodiments 16 to 18 may be configured in a manner such that the screen is the light-emitting screen and further comprises a mirror which is disposed behind the screen from the user's point of view, such that the user can see in the mirror the combination of the objects transmitted or reflected by the screen with the hair projection region.

In accordance with a twentieth exemplary embodiment, the device in accordance with one of the exemplary embodiments 16 to 19 may be configured in a manner such that the input device comprises a touch-sensitive surface of the screen.

In accordance with a twenty-first exemplary embodiment, the device in accordance with one of the exemplary embodiments 16 to 20 may further comprise:

a sensor to acquire spatial information regarding the user.

In accordance with a twenty-second exemplary embodiment, a method for presenting a hair color result may comprise:

a plurality of coloring processes for each coloring process: colorimetric measurement of uncolored hair for a plurality of measuring points;
determining a “before” mean color value from the colorimetric measured values for the plurality of measuring points for the uncolored hair;
colorimetric measurement of colored hair for a plurality of measuring points;
determining an “after” mean color value from the colorimetric measured values for the plurality of measuring points for the colored hair; and
determining a color difference value from the “before” mean color value and the “after” mean color value, incorporating correction factors for very dark or very light points;
determining a relationship between the plurality of “before” mean color values and the plurality of color difference values using predictive analytics;
providing a digital image which comprises at least one hair region area of a user, determining color values for a plurality of image elements of the user hair region area;
determining a user “before” mean color value from the color values for the plurality of image elements from the user hair region area;
selection of a new hair color by the user;
determining an expected color result using the user “before” mean color value and the determined relationship; and
presenting the expected color result by displaying at least a portion of the digital image in which the hair region area is recolored with the aid of the expected color result.

In accordance with a twenty-third exemplary embodiment, the method in accordance with exemplary embodiment 22 may be configured in a manner such that the determination of an expected color result comprises:

determining an associated color difference value with the aid of the determined relationship; and
wherein the new color of the hair region area comprises re-coloring the plurality of image elements of the user hair region area by adding the color difference value to the determined color value for each image element of the plurality of image elements of the user hair region area.

In accordance with a twenty-fourth exemplary embodiment, the method in accordance with exemplary embodiment 22 or 23 may be configured in a manner such that, in order to present the portion of the digital image which comprises the recolored hair region area, a device in accordance with one of the exemplary embodiments 16 to 21 is used.

Further advantageous embodiments of the method will become apparent from the description of the device, and vice versa.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the various embodiments in any way. Rather, the foregoing detailed description will provide those skilled in the art with a convenient road map for implementing an exemplary embodiment as contemplated herein. It being understood that various changes may be made in the function and arrangement of elements described in an exemplary embodiment without departing from the scope of the various embodiments as set forth in the appended claims.

1. A method for computer-aided hair color counseling, comprising:
recording a digital image of hair of a user and additional objects by employing a camera;
identifying a hair region area in the digital image in which the hair is depicted;
identifying a new hair color;
aligning a hair projection region in which the hair is projected by a transparent screen or a reflecting screen or a system of screen and a one way mirror in a manner such that, to an observer of the screen, a combination of the objects projected by the screen is produced with the hair projection region, wherein the hair projection region is aligned in a manner such that it essentially covers a hair transmission/reflection region in which, to the observer, the projected user's hair would appear; and
projecting the hair projection region in the new hair color.

2. The method as claimed in claim 1,
wherein recording the digital image, identifying the hair region area and presenting the hair projection region colored with the new hair color is repeated in a manner such that a quasi-real time presentation is produced.

3. The method as claimed in claim 1,
wherein the identification of the new hair color comprises selecting the new hair color from a plurality of selectable new hair colors provided by employing a database.

4. The method as claimed in claim 1,
wherein identifying the new hair color comprises measuring a hair coloring product by employing a sensor.

5. The method as claimed in claim 1, further comprising:
correcting the new hair color by employing a color and/or brightness reference.

6. The method as claimed in claim 1,
wherein aligning of the hair projection region comprises arranging the user, the screen, the observer and the camera in a manner such that the hair projection region covers the hair transmission/reflection region when the hair projection region of the hair region area corresponds to a mirror image configuration of the whole digital image which fills the screen.

7. The method as claimed in claim 1,
wherein alignment of the hair projection region comprises recording a positional reference.

8. The method as claimed in claim 1,
wherein alignment of the hair projection region comprises recording spatial information regarding the user and the additional objects.

9. The method as claimed in claim 1, further comprising:
projecting the hair projection region in an original hair color of the user.

10. The method as claimed in claim 1, further comprising:
presenting at least one colorant which is associated with the selectable new hair color.

11. A device for carrying out computer-aided hair color counseling, comprising:
at least one camera to record a digital image of hair of a user and additional objects;
a processor, wherein the processor is configured to identify a hair region area in the digital image of the user;
an input device for the user to select a new hair color; and
a light-transmitting or reflecting screen to project a hair projection region in the new hair color, wherein the hair projection region is aligned in a manner such that, for an observer of the screen, a combination of the objects transmitted or reflected by the screen is produced with the hair projection region, in which the hair projection region about covers a hair transmission/reflection region in which, to the observer, the transmitted or reflected hair of the user would appear.

12. The device as claimed in claim 11,
wherein the screen is an OLED screen.

13. The device as claimed in claim 11,
wherein the at least one camera is disposed in a manner such that the camera has at least one optical axis that is perpendicular to a surface of the screen facing the user.

14. The device as claimed in claim 11,
wherein the screen is the light-emitting screen, further comprising:
a mirror which is disposed behind the screen from the user's point of view, such that the user can see in the mirror the combination of the objects transmitted or reflected by the screen with the hair projection region.

15. A method for presenting a hair color result comprising:
for each coloring process of a plurality of coloring processes:
measuring a colorimetric measurement of uncolored hair for a plurality of measuring points;
determining a plurality of “before” mean color value from the colorimetric measured values for the plurality of measuring points for the uncolored hair;
measuring a colorimetric measurement of colored hair for a plurality of measuring points;
determining an “after” mean color value from the colorimetric measured values for the plurality of measuring points for the colored hair;
determining a plurality of color difference value from the plurality of “before” mean color value and the “after” mean color value;
incorporating correction factors for a very dark or a very light point;
determining a relationship between the plurality of “before” mean color values and the plurality of color difference values using predictive analytics; and
providing a digital image which comprises at least one hair region area of a user;
determining color values for a plurality of image elements of the user hair region area;
determining a user “before” mean color value from the color values for the plurality of image elements from the user hair region area;
selection of a new hair color by the user;
determining an expected color result using the user “before” mean color value and the determined relationship; and
presenting the expected color result by displaying at least a portion of the digital image in which the hair region area is recolored with the aid of the expected color result.

16. The device as claimed in claim 11 wherein:
the camera comprises two 3D cameras disposed at a distance from each other suitable for recording 3D images.

17. The device as claimed in claim 11 wherein:
the camera is integrated into the screen.

18. The device as claimed in claim 11 wherein:
the additional objects comprise a positional reference.

19. The method as claimed in claim 1 wherein:
recording the digital image of the hair comprises recording a 3D image of the hair.
